(19) United States
(12) Patent Application Publication
(10) Pub. No.: US 2008/0293851 A1
(43) Pub. Date: Nov. 27, 2008

(54) Use of Solid Pigment Preparations for Dyeing Composite Cellulose/Polymer Materials

(75) Inventors: Andres Carlos Garcia Espino, Mannheim (DE); Juliane Krusemann, Ludwigshafen (DE); Werner Peter, Hackettstown, NJ (US)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/913,321

(22) PCT Filed: Apr. 28, 2006
(86) PCT No.: PCT/EP2006/061924

§ 371 Date: Jun. 27, 2008

(30) Foreign Application Priority Data
May 2, 2005 (DE) 10 2005 020 742.1

(51) Int. Cl. C08L 1/02

(52) U.S. Cl. 524/35

(57) ABSTRACT

Solid pigment preparations comprising, as essential constituents,
(A) 30% to 90% by weight of at least one pigment
   and
(B) 10% to 70% by weight of at least one water-soluble surface-active additive
   are useful for coloring cellulose polymer compounds or composites.

The present invention relates to the use of solid pigment preparations comprising, as essential constituents,

(A) 30% to 90% by weight of at least one pigment
and
   (B) 10% to 70% by weight of at least one water-soluble surface-active additive
   for coloring cellulose polymer compounds or composites.

Cellulose polymer compounds or composites, in particular lignocellulose polymer or wood polymer or plastic compounds or composites (WPCs) have the properties of both wood and plastic. They are further advantageous because they can be produced on the basis of raw materials from recycling. They are of interest for a multiplicity of applications. An example is their use as a structural element in the building construction industry, for example as a dividing wall, as a roof, as a floor, as a window frame and as lining, and also as packaging material.

The cellulose particles used in the compounds or composites may have different morphologies and accordingly different largest particle diameters ranging from about 1 to 10 mm (shavings) to 0.1 to 1 mm for fibers to 0.01 to 0.1 mm (dust). The finer the cellulose particles, the greater the holding capacity of the polymer matrix for these particles, but the tensile strength of the compound or composite decreases in the same direction.

Wood is currently the preferred cellulose material, not only softwoods, examples being pinewood and cedarwood, but also hardwoods, examples being oak and maple. Other vegetable materials are similarly useful, examples being fibers of sisal, flax, hemp, jute, cotton and other cereals, bamboo, straw, reed, coir, banana fibers, flax shives, rice-hulls and peanut shells.

Thermoplastic polymers are used in general. Preferred polymers in particular are polyethylene, polypropylene and polyvinyl chloride, but it will be appreciated that other polymers are similarly useful, such as ABS (graft copolymers of acrylonitrile and styrene on butadiene rubbers), ASA (graft copolymers of styrene and acrylonitrile on polyalkyl acrylate rubbers), SAN (styrene-acrylonitrile copolymers) and PU (polyurethanes).

The mixing ratio is generally 40% to 95% by weight of cellulose particles and 5% to 60% by weight of polymer.

The cellulose polymer compounds or composites are generally produced by first producing a mixed granulate to equalize the density difference between polymer and cellulose particles. To produce the mixed granulate, polymer and cellulose particles are first metered into a heated mixer, in which the polymer is melted and mixed with the cellulose particles. This mixture is then granulated in a cooling mixer. The granulate is subsequently extruded and can be brought into the desired form by injection molding.

In general, additives are used to increase the compatibility between the cellulose component and the polymer component and/or the interphase adhesion (examples being maleic acid modified polyolefins or isocyanates) or enhance the processibility for extrusion (examples being resins, waxes).

It is further customary to employ additives to modify the technical properties of the compounds or composites (tensile strength, density, flexibility, impact sensitivity, thermal stability), for their mechanical or chemical protection, to extend their useful lives and to enhance their esthetic appeal. Such additives may be for example foaming agents to expand the polymer matrix, flow additives, thermal stabilizers, biocides, insecticides, antioxidants, UV absorbers, antistats, flame retardants, fillers and colorants.

Various ways are known to color cellulose polymer compounds or composites.

DE-A-20 42 496 describes granular colorant concentrates comprising 20% by weight of a 1:1 mixture of C.I. Pigment Blue 15 and a blue reactive dye or 20% by weight of just the pigment or dye and 80% by weight of a polyethylene wax. The concentrates are mixed with wood flour and polymer component and then jointly extruded.

WO-A-02/103113 has composites based on wood flour which confer the impression of a wood grain at the surface being produced by adding a combination of pigment-olefin masterbatch and unspecified liquid colorant at extrusion.

US-A-2004/0076847 discloses composites based on polyvinyl chloride and wood flour which has been colored with an aqueous dispersion of a pigment. Pigments identified as preferred include metal oxide pigments, such as iron (III) oxide and manganese antimony titanate, and also copper phthalocyanine. The possibility of dyeing with an aqueous solution of the dye is also mentioned.

EP-A-888 870 describes packaging materials based on transparent composites having a low fraction of wood fiber. It is mentioned that the transparent polymer can be colored with dye solutions or the wood fibers can be coated with colored material.

Finally, US-A-2002/0040557 discloses construction panels for shingling based on cellulose polymer composites produced by pressing a mixture of cellulose fibers, polymer, maleic acid grafted polyolefin as a coupling agent, UV absorber, thermal stabilizer, iron oxide pigment, fungicide and flame retardant.

None of the known ways to produce colored cellulose polymer compounds or composites utilizes solid pigment preparations comprising pigment and water-soluble surface-active additive and having a pigment content >20% by weight.

It is an object of the present invention to provide colorant formulations for advantageous coloration of cellulose polymer compounds or composites.

We have found that this object is achieved by the use of solid pigment preparations comprising, as essential constituents,

(A) 30% to 90% by weight of at least one pigment
and
   (B) 10% to 70% by weight of at least one water-soluble surface-active additive for coloring cellulose polymer compounds or composites.

Such pigment preparations are known and described, for example, in A-03/64540, 03/66743, 04/00903, 04/50770 and 04/46251 where they are used for coloring coating systems.

The pigment preparations can be used in the form of a powder or of a granulate. It is particularly advantageous that they are extremely easy to disperse in water and therefore have a coloring effect as soon as they come into contact with small amounts of water. The residue moisture content of cellulose chips or fibers will generally be sufficient, so that very little if any additional water has to be introduced into the manufacturing operation of the cellulose polymer compounds or composites and subsequently removed again.

Component (A) in the pigment preparations to be used according to the present invention may comprise organic or inorganic pigments. It will be appreciated that the colorant preparations may also comprise mixtures of various organic or various inorganic pigments or mixtures of organic and inorganic pigments.

The pigments are preferably present in finely divided form. Accordingly, the pigments typically have average particle sizes from 0.1 to 5 μm, in particular from 0.1 to 3 μm and especially from 0.1 to 1 μm.

Depending on the effect desired, the pigments may be used in transparent, semi-transparent or hiding form.

The organic pigments are typically organic chromatic and black pigments. Inorganic pigments can likewise be color pigments (chromatic, black and white pigments) and also luster pigments.

There now follow examples of suitable organic color pigments:

| | |
|---|---|
| monoazo pigments: | C.I. Pigment Brown 25; |
| | C.I. Pigment Orange 5, 13, 36, 38, 64 and 67; |
| | C.I. Pigment Red 1, 2, 3, 4, 5, 8, 9, 12, 17, 22, 23, |
| | 31, 48:1, 48:2, 48:3, 48:4, 49, 49:1, 51:1, 52:1, |
| | 52:2, 53, 53:1, 53:3, 57:1, 58:2, 58:4, 63, 112, |
| | 146, 148, 170, 175, 184, 185, 187, 191:1, 208, |
| | 210, 245, 247 and 251; |
| | C.I. Pigment Yellow 1, 3, 62, 65, 73, 74, 97, 120, |
| | 151, 154, 168, 181, 183 and 191; |
| | C.I. Pigment Violet 32; |
| disazo pigments: | C.I. Pigment Orange 16, 34, 44 and 72; |
| | C.I. Pigment Yellow 12, 13, 14, 16, 17, 81, 83, |
| | 106, 113, 126, 127, 155, 174, 176, 180 and 188; |
| condensed disazo pigments: | C.I. Pigment Yellow 93, 95 and 128; |
| | C.I. Pigment Red 144, 166, 214, 220, 221, 242 |
| | and 262; |
| | C.I. Pigment Brown 23 and 41; |
| anthanthrone pigments: | C.I. Pigment Red 168; |
| anthraquinone pigments: | C.I. Pigment Yellow 147, 177 and 199; |
| | C.I. Pigment Violet 31; |
| anthrapyrimidine pigments: | C.I. Pigment Yellow 108; |
| quinacridone pigments: | C.I. Pigment Orange 48 and 49; |
| | C.I. Pigment Red 122, 202, 206 and 209; |
| | C.I. Pigment Violet 19; |
| quinophthalone pigments: | C.I. Pigment Yellow 138; |
| diketopyrrolopyrrole pigments: | C.I. Pigment Orange 71, 73 and 81; |
| | C.I. Pigment Red 254, 255, 264, 270 and 272; |
| dioxazine pigments: | C.I. Pigment Violet 23 and 37; |
| | C.I. Pigment Blue 80; |
| flavanthrone pigments: | C.I. Pigment Yellow 24; |
| indanthrone pigments: | C.I. Pigment Blue 60 and 64; |
| isoindoline pigments: | C.I. Pigments Orange 61 and 69; |
| | C.I. Pigment Red 260; |
| | C.I. Pigment Yellow 139 and 185; |
| isoindolinone pigments: | C.I. Pigment Yellow 109, 110 and 173; |
| isoviolanthrone pigments: | C.I. Pigment Violet 31; |
| metal complex pigments: | C.I. Pigment Red 257; |
| | C.I. Pigment Yellow 117, 129, 150, 153 and 177; |
| | C.I. Pigment Green 8; |
| perinone pigments: | C.I. Pigment Orange 43; |
| | C.I. Pigment Red 194; |
| perylene pigments: | C.I. Pigment Black 31 and 32; |
| | C.I. Pigment Red 123, 149, 178, 179, 190 and |
| | 224; |
| | C.I. Pigment Violet 29; |
| phthalocyanine pigments: | C.I. Pigment Blue 15, 15:1, 15:2, 15:3, 15:4, 15:6 |
| | and 16; |
| | C.I. Pigment Green 7 and 36; |
| pyranthrone pigments: | C.I. Pigment Orange 51; |
| | C.I. Pigment Red 216; |
| pyrazoloquinazolone pigments: | C.I. Pigment Orange 67; |
| | C.I. Pigment Red 251; |
| thioindigo pigments: | C.I. Pigment Red 88 and 181; |
| | C.I. Pigment Violet 38; |
| triarylcarbonium pigments: | C.I. Pigment Blue 1, 61 and 62; |
| | C.I. Pigment Green 1; |
| | C.I. Pigment Red 81, 81:1 and 169; |
| | C.I. Pigment Violet 1, 2, 3 and 27; |
| | C.I. Pigment Black 1 (aniline black); |
| | C.I. Pigment Yellow 101 (aldazine yellow); |
| | C.I. Pigment Brown 22. |

Examples of suitable inorganic color pigments are:

| | |
|---|---|
| white | titanium dioxide (C.I. Pigment White 6), zinc white, |
| pigments: | pigment grade zinc oxide; zinc sulfide, lithopone; |
| black | iron oxide black (C.I. Pigment Black 11), iron manganese |
| pigments: | black, spinel black (C.I. Pigment Black 27); carbon black |
| | (C.I. Pigment Black 7); |
| chromatic | chromium oxide, chromium oxide hydrate green; chrome |
| pigments: | green (C.I. Pigment Green 48); cobalt green (C.I. |
| | Pigment Green 50); ultramarine green; |
| | cobalt blue (C.I. Pigment Blue 28 and 36; C.I. Pigment |
| | Blue 72); ultramarine blue; manganese blue; |
| | ultramarine violet; cobalt violet and manganese violet; |
| | red iron oxide (C.I. Pigment Red 101); cadmium |
| | sulfoselenide (C.I. Pigment Red 108); cerium sulfide (C.I. |
| | Pigment Red 265); molybdate red (C.I. Pigment Red |
| | 104); ultramarine red; |
| | brown iron oxide (C.I. Pigment Brown 6 and 7), mixed |
| | brown, spinet phases and corundum phases (C.I. |
| | Pigment Brown 29, 31, 33, 34, 35, 37, 39 and 40), |
| | chromium titanium yellow (C.I. Pigment Brown 24), |
| | chrome orange; |
| | cerium sulfide (C.I. Pigment Orange 75); |
| | yellow iron oxide (C.I. Pigment Yellow 42); nickel titanium |
| | yellow (C.I. Pigment Yellow 53; C.I. Pigment Yellow 157, |
| | 158, 159, 160, 161, 162, 163, 164 and 189); chromium |
| | titanium yellow; spinel phases (C.I. Pigment Yellow 119); |
| | cadmium sulfide and cadmium zinc sulfide (C.I. Pigment |
| | Yellow 37 and 35); chrome yellow (C.I. Pigment Yellow |
| | 34); bismuth vanadate (C.I. Pigment Yellow 184). |

Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

The pigments will be chosen specifically in line with the planned application for the compound or composite. For example, high-lightfastness pigments, such as inorganic pigments and organic pigments from the perylene, indanthrone and copper phthalocyanine series, are useful for exterior applications. By using conductive carbon black it is possible to obtain conductive compounds or composites which are of interest for antistatic liners. Transparent iron oxide pigments, especially FeOOH pigments, can be used to advantageously enhance the wood hue of the cellulosic particles. It is further particularly advantageous when these pigments also act as UV absorbers and hence enhance the stability of the cellulose polymer compound or composite.

Component (B) in the pigment preparations to be used according to this invention is at least one water-soluble surface-active additive.

Particularly suitable surface-active additives (B) are nonionic and anionic water-soluble surface-active additives.

Particularly suitable nonionic additives (B) are based on polyethers (additives (B1)).

As well as unmixed polyalkylene oxides, preferably C₂-C₄-alkylene oxides and phenyl-substituted C₂-C₄-alkylene oxides, especially polyethylene oxides, polypropylene oxides and poly(phenylethylene oxide)s, it is in particular block copolymers, especially polymers which contain polypropylene oxide and polyethylene oxide blocks or poly(phenylethylene oxide) and polyethylene oxide blocks, and also random copolymers of these alkylene oxides which are suitable.

These polyalkylene oxides are preparable by polyaddition of the alkylene oxides to starter molecules, as to saturated or unsaturated aliphatic and aromatic alcohols, to phenol or naphthol, which may each be substituted by alkyl, especially C₁-C₁₂-alkyl, preferably C₄-C₁₂-alkyl and C₁-C₄-alkyl respectively, to saturated or unsaturated aliphatic and aromatic amines and to saturated or unsaturated aliphatic carboxylic acids and carboxamides. It is customary to use from 1 to 300 mol and preferably from 3 to 150 mol of alkylene oxide per mole of starter molecule.

Suitable aliphatic alcohols comprise in general from 6 to 26 carbon atoms and preferably from 8 to 18 carbon atoms and can have an unbranched, branched or cyclic structure. Examples are octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptylundecanol, 2-octyldecanol, 2-nonyltridecanol, 2-decyltetradecanol, oleyl alcohol and 9-octadecenol and also mixtures of these alcohols, such as C₈/C₁₀, C₁₃/C₁₅ and C₁₆/C₁₈ alcohols, and cyclopentanol and cyclohexanol. Of particular interest are the saturated or unsaturated fatty alcohols obtained from natural raw materials by fat hydrolysis and reduction and the synthetic fatty alcohols from the oxo process. The alkylene oxide adducts with these alcohols typically have average molecular weights Mₙ from 200 to 5000.

Examples of the abovementioned aromatic alcohols include not only unsubstituted phenol and α- and β-naphthol but also hexylphenol, heptylphenol, octylphenol, nonylphenol, isononylphenol, undecylphenol, dodecylphenol, di- and tributylphenol and dinonylphenol.

Suitable aliphatic amines correspond to the abovementioned aliphatic alcohols. Again of particular importance here are the saturated and unsaturated fatty amines which preferably have from 14 to 20 carbon atoms. Examples of suitable aromatic amines are aniline and its derivatives.

Useful aliphatic carboxylic acids include especially saturated and unsaturated fatty acids which preferably comprise from 14 to 20 carbon atoms and fully hydrogenated, partially hydrogenated and unhydrogenated resin acids and also polyfunctional carboxylic acids, for example dicarboxylic acids, such as maleic acid.

Suitable carboxamides are derived from these carboxylic acids.

As well as alkylene oxide adducts with monofunctional amines and alcohols it is alkylene oxide adducts with at least bifunctional amines and alcohols which are of very particular interest.

The at least bifunctional amines preferably have from 2 to 5 amine groups and conform in particular to the formula H₂N—(R¹—NR²)n—H(R¹: C₂-C₆-alkylene; R²: hydrogen or C₁-C₆-alkyl; n: 1-5). Specific examples are: ethylenediamine, diethylenetriamine, triethylenetetramine, tetraethylenepentamine, 1,3-propylenediamine, dipropylene-triamine, 3-amino-1-ethyleneaminopropane, hexamethylenediamine, dihexamethylene-triamine, 1,6-bis(3-aminopropylamino)hexane and N-methyldipropylenetriamine, of which hexamethylenediamine and diethylenetriamine are more preferable and ethylenediamine is most preferable.

These amines are preferably reacted first with propylene oxide and then with ethylene oxide. The ethylene oxide content of the block copolymers is typically about 10-90% by weight.

The average molecular weights Mₙ of the block copolymers based on polyamines are generally in the range from 1000 to 40 000 and preferably in the range from 1500 to 30 000.

The at least bifunctional alcohols preferably have from two to five hydroxyl groups. Examples are C₂-C₆-alkylene glycols and the corresponding di- and polyalkylene glycols, such as ethylene glycol, 1,2-propylene glycol, 1,3-propylene glycol, 1,2-butylene glycol, 1,4-butylene glycol, 1,6-hexylene glycol, dipropylene glycol and polyethylene glycol, glycerol and pentaerythritol, of which ethylene glycol and polyethylene glycol are more preferable and propylene glycol and dipropylene glycol are most preferable.

Particularly preferred alkylene oxide adducts with at least bifunctional alcohols have a central polypropylene oxide block, i.e., are based on a propylene glycol or polypropylene glycol which is initially reacted with further propylene oxide and then with ethylene oxide. The ethylene oxide content of the block copolymers is typically in the range from 10% to 90% by weight.

The average molecular weights Mₙ of the block copolymers based on polyhydric alcohols are generally in the range from 1000 to 20 000 and preferably in the range from 1000 to 15 000.

Such alkylene oxide block copolymers are known and commercially obtainable, for example under the names Tetronic® and Pluronic® (BASF).

Examples of the water-soluble anionic surface-active agents particularly suitable for use as component (B) are additives based on polymers of ethylenically unsaturated carboxylic acids (B2), additives based on polyurethanes (B3), additives based on acidic phosphoric, phosphonic, sulfuric and/or sulfonic esters of the abovementioned polyethers (B4) and additives based on polycondensation products of aromatic sulfonic acids and formaldehyde (B5).

Mixtures of a plurality of additives (B) can also be used of course, i.e., not only mixtures of various nonionic additives but also mixtures of various anionic additives and also mixtures of nonionic and anionic additives.

Useful anionic water-soluble surface-active additives based on polymers of unsaturated carboxylic acids (B2) include in particular additives from the group of the homo- and copolymers of ethylenically unsaturated monocarboxylic acids and/or ethylenically unsaturated dicarboxylic acids, which may further comprise interpolymerized vinyl monomers without acid function, the alkoxylation products of these homo- and copolymers and the salts of these homo- and copolymers and their alkoxylation products.

Examples which may be mentioned of the carboxyl-containing monomers and the vinyl monomers are:
acrylic acid, methacrylic acid and crotonic acid;
maleic acid, maleic anhydride, maleic monoesters, maleic monoamides, reaction products of maleic acid with diamines that may have been oxidized to derivatives containing amine oxide groups, and fumaric acid, of which maleic acid, maleic anhydride and maleic monoamides are preferred;
vinylaromatics, such as styrene, methylstyrene and vinyltoluene; ethylene, propylene, isobutene, diisobutene and butadiene; vinyl ethers, such as polyethylene glycol monovinyl ether; vinyl esters of linear or branched monocarboxylic acids, such as vinyl acetate and vinyl propionate; alkyl esters and aryl esters of ethylenically unsaturated monocarboxylic acids, especially acrylic and methacrylic esters, such as methyl, ethyl, propyl, isopropyl, butyl, pentyl, hexyl, 2-ethylhexyl, nonyl, lauryl and hydroxyethyl(meth)acrylates and also phenyl, naphthyl and benzyl(meth)acrylates; dialkyl esters of ethylenically unsaturated dicarboxylic acids, such as dimethyl, diethyl, dipropyl, diisopropyl, dibutyl, dipentyl, dihexyl, di-2-ethylhexyl, dinonyl, dilauryl and di-2-hydroxyethyl maleates and fumarates; vinylpyrrolidone; acrylonitrile and methacrylonitrile, of which styrene, isobutene, diisobutene, acrylic esters and polyethylene glycol monovinyl ether are preferred.

Polyacrylic acids in particular are to be mentioned as examples of preferred homopolymers of these monomers.

The copolymers of the monomers mentioned may be constructed from two or more and in particular three different monomers. The copolymers may be random copolymers, alternating copolymers, block copolymers and graft copolymers. Preferred copolymers are styrene-acrylic acid, acrylic acid-maleic acid, acrylic acid-methacrylic acid, butadiene-acrylic acid, isobutene-maleic acid, diisobutene-maleic acid and styrene-maleic acid copolymers which may each comprise acrylic esters and/or maleic esters as additional monomeric constituents.

Preferably, the carboxyl groups of the nonalkoxylated homo- and copolymers are at least partly present in salt form in order that solubility in water may be ensured. Suitable examples are alkali metal salts, such as sodium and potassium salts, and ammonium salts.

The average molecular weight M_{w} of the nonalkoxylated polymeric additives (B2) is typically in the range from 900 to 250 000. The molecular weight ranges particularly suitable for the individual polymers are naturally dependent on their composition. Exemplary molecular weight ranges for various polymers are as follows: polyacrylic acids: M_{w} from 900 to 250 000; styrene-acrylic acid copolymers: M_{w} from 1000 to 50 000; acrylic acid-methacrylic acid copolymers: M_{w} from 1000 to 250 000; acrylic acid-maleic acid copolymers: M_{w} from 2000 to 70 000.

As well as these homo- and copolymers themselves, their alkoxylation products are also of particular interest for use as additives (B2).

Alkoxylation products here refers in particular to the partial to (insofar as possible) complete esterification products of these polymers with polyether alcohols. The degree of esterification of these polymers is generally in the range from 30 to 80 mol %. Useful esterifying agents include in particular the polyether alcohols themselves, preferably polyethylene glycols and polypropylene glycols, and also their singlesidedly end group capped derivatives, especially the corresponding monoethers, such as monoaryl ethers, for example monophenyl ethers, and in particular mono-C₁-C₂₆-alkyl ethers, for example glycols of ethylene and propylene which are etherified with fatty alcohols, and the polyether amines which are preparable for example by converting a terminal OH group of the corresponding polyether alcohols or by polyaddition of alkylene oxides onto preferably primary aliphatic amines. Polyethylene glycols, polyethylene glycol monoethers and polyetheramines are preferred here. The average molecular weights Mₙ of the employed polyether alcohols and their derivatives are typically in the range from 200 to 10 000.

Specific surface-active properties can be achieved for the additives (B2) via the ratio of polar to apolar groups.

Such anionic surface-active additives (B2) are likewise known and commercially available for example under the names of Sokalan® (BASF), Joncryl® (Johnson Polymer), Alcosperse® (Alco), Geropon® (Rhodia), Good-Rite® (Goodrich), Neoresin® (Avecia), Orotan® and Morez® (Rohm & Haas), Disperbyk® (Byk) and also Tegospers® (Goldschmidt).

Useful anionic surface-active additives for the pigment preparations of the present invention further include polyurethane-based additives (B3).

For the purposes of the present invention, polyurethane shall be understood as referring not just to the pure reaction products of polyfunctional isocyanates (B3a) with isocyanate-reactive hydroxyl-comprising organic compounds (B3b), but also reaction products which have been additionally functionalized by the addition of further isocyanate-reactive compounds, for example by the addition of carboxylic acids bearing primary or secondary amino groups.

These additives are distinguished from other surface-active additives by their low ionic conductivity and their neutral pH.

Useful polyfunctional isocyanates (B3a) for the preparation of the additives (B3) include in particular diisocyanates, but it is also possible to use compounds having three or four isocyanate groups. Not only aromatic but also aliphatic isocyanates can be used.

As examples of preferred di- and triisocyanates there may be recited: 2,4-tolylene diisocyanate (2,4-TDI), 4,4′-diphenylmethane diisocyanate (4,4′-MDI), para-xylylene diisocyanate, 1,4-diisocyanatobenzene, tetramethylxylylene diisocyanate (TMXDI), 2,4′-diphenylmethane diisocyanate (2,4′-MDI) and triisocyanatotoluene and also isophorone diisocyanate (IPDI), 2-butyl-2-ethylpentamethylene diisocyanate, tetramethylene diisocyanate, hexamethylene diisocyanate, dodecamethylene diisocyanate, 2,2-bis(4-isocyanatocyclohexyl)propane, trimethylhexane diisocyanate, 2-isocyanatopropylcyclohexyl isocyanate, 2,4,4- and 2,2,4-trimethylhexamethylene diisocyanates, 2,4′-methylene bis(cyclohexyl)diisocyanate, cis-cyclohexane 1,4-diisocyanate, transcyclohexane 1,4-diisocyanate and 4-methylcyclohexane 1,3-diisocyanate (H-TDI).

It will be appreciated that mixtures of isocyanates (B3a) can be used as well. As examples there may be mentioned here: mixtures of structural isomers of 2,4-tolylene diisocyanate and triisocyanatotoluene, for example mixtures of 80 mol % of 2,4-tolylene diisocyanate and 20 mol % of 2,6-tolylene diisocyanate; mixtures of cis- and trans-cyclohexane 1,4-diisocyanates; mixtures of 2,4- or 2,6-tolylene diisocyanate with aliphatic diisocyanates, such as hexamethylene diisocyanate and isophorone diisocyanate.

Preferred isocyanate-reactive organic compounds (B3b) are compounds having at least two isocyanate-reactive hydroxyl groups per molecule. However, useful B3b compounds further include compounds which have only one isocyanate-reactive hydroxyl group per molecule. These monofunctionalized compounds may partly or else wholly replace the compounds comprising at least two isocyanate-reactive hydroxyl groups per molecule in the reaction with the polyisocyanate (B3a).

Examples of particularly preferred isocyanate-reactive compounds (B3b) having at least two isocyanate-reactive hydroxyl groups per molecule will now be recited.

They are polyether diols, polyester diols, polyester diols based on lactone, diols and triols with up to 12 carbon atoms, dihydroxy carboxylic acids, dihydroxy sulfonic acids, dihydroxy phosphonic acids, polycarbonate diols, polyhydroxy olefins and polysiloxanes having on average at least two hydroxyl groups per molecule.

Useful polyether diols (B3b) include for example homo- and copolymers of C₂-C₄-alkylene oxides, such as ethylene oxide, propylene oxide and butylene oxide, tetrahydrofuran, styrene oxide and/or epichlorohydrin, which are obtainable in the presence of a suitable catalyst, for example boron trifluoride. Useful polyether diols are further obtainable by (co)polymerization of these compounds in the presence of a starter having at least two acidic hydrogen atoms, examples of starters being water, ethylene glycol, thioglycol, mercaptoethanol, 1,3-propanediol, 1,4-butanediol, 1,6-hexanediol, 1,12-dodecanediol, ethylenediamine, aniline or 1,2-di-(4-hydroxyphenyl)propane.

Examples of particularly suitable polyether diols (B3b) are polyethylene glycol, polypropylene glycol, polybutylene glycol and polytetrahydrofuran and also copolymers thereof.

The molecular weight Mₙ of the polyether diols is preferably in the range from 250 to 5000 and more preferably in the range from 500 to 2500.

Polyester diols (hydroxy polyesters) useful as an isocyanate-reactive compound (B3b) are common knowledge.

Preferred polyester diols (B3b) are the reaction products of diols with dicarboxylic acids or their reactive derivatives, examples being anhydrides or dimethyl esters.

Useful dicarboxylic acids are saturated and unsaturated aliphatic and also aromatic dicarboxylic acids, which may bear additional substituents, such as halogen. Preferred aliphatic dicarboxylic acids are saturated unbranched α,ω-dicarboxylic acids comprising 3 to 22 and especially 4 to 12 carbon atoms.

Examples of particularly suitable dicarboxylic acids are: succinic acid, glutaric acid, adipic acid, suberic acid, azelaic acid, sebacic acid, 1,12-dodecanedicarboyxlic acid, maleic acid, maleic anhydride, fumaric acid, itaconic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, terephthalic acid, dimethyl terephthalate and dimethyl isophthalate.

Useful diols include in particular saturated and unsaturated aliphatic and cycloaliphatic diols. The particularly preferred aliphatic α,ω-diols are unbranched and have 2 to 12, in particular 2 to 8, especially 2 to 4 carbon atoms. Preferred cycloaliphatic diols are derived from cyclohexane.

Examples of particularly suitable diols are: ethylene glycol, propylene glycol, 1,3-propanediol, 1,4-butanediol, 2-methylpropane-1,3-diol, 1,5-pentanediol, neopentyl glycol, 1,6-hexanediol, 1,8-octanediol, 1,10-decanediol, 1,12-dodecanediol, cis-but-2-ene-1,4-diol, trans-but-2-ene-1,4-diol, 2-butyne-1,4-diol, cis-1,4-di(hydroxymethyl)-cyclohexane and trans-1,4-di(hydroxymethyl)cyclohexane.

The molecular weight Mₙ of the polyester diols is preferably in the range from 300 to 5000.

Lactone-based polyester diols useful as an isocyanate-reactive compound (B3b) are based in particular on aliphatic saturated unbranched ω-hydroxy carboxylic acids having 4 to 22 and preferably 4 to 8 carbon atoms. It is also possible to use branched ω-hydroxy carboxylic acids wherein one or more —CH₂— groups in the alkylene chain are replaced by —CH(C₁-C₄-alkyl)-.

Examples of preferred ω-hydroxy carboxylic acids are γ-hydroxybutyric acid and δ-hydroxyvaleric acid.

It will be appreciated that the abovementioned diols may likewise be used as isocyanate-reactive compounds (B3b), in which case the same preferences as above apply.

Triols, in particular triols having 3 to 12 and especially 3 to 8 carbon atoms, are likewise useful as isocyanate-reactive compounds (B3b). Trimethylolpropane is an example of a particularly suitable triol.

Dihydroxy carboxylic acids useful as isocyanate compounds (B3b) are in particular aliphatic saturated dihydroxy carboxylic acids which preferably comprise 4 to 14 carbon atoms. Dihydroxy carboxylic acids of the formula

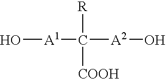

where A¹ and A² represent identical or different C₁-C₄-alkylene radicals and R represents hydrogen or C₁-C₄-alkyl, are very particularly suitable.

Dimethylolpropionic acid (DMPA) is a particularly preferred example of these dihydroxy carboxylic acids.

Useful isocyanate-reactive compounds (B3b) further include the corresponding dihydroxy sulfonic acids and dihydroxy phosphonic acids, such as 2,3-dihydroxy-propanephosphonic acid.

Dihydroxy carboxylic acid as used herein shall also comprise compounds comprising more than one carboxyl function (or as the case may be anhydride or ester function). Such compounds are obtainable by reaction of dihydroxy compounds with tetracarboxylic dianhydrides, such as pyromellitic dianhydride or cyclopentane-tetracarboxylic dianhydride, in a molar ratio from 2:1 to 1.05:1 in a polyaddition reaction, and preferably have an average molecular weight Mₙ in the range from 500 to 10 000.

Examples of useful polycarbonate diols (B3b) are the reaction products of phosgene with an excess of diols, in particular unbranched saturated aliphatic α,ω-diols having 2 to 12, in particular 2 to 8 and especially 2 to 4 carbon atoms.

Polyhydroxyolefins useful as an isocyanate-reactive compound (B3b) are in particular α,ω-dihydroxyolefins, and α,ω-dihydroxybutadienes are preferred.

The polysiloxanes useful as an isocyanate-reactive compound (B3b) comprise on average at least two hydroxyl groups per molecule. Particularly suitable polysiloxanes comprise on average 5 to 200 silicon atoms (number average) and are in particular substituted by C₁-C₁₂-alkyl groups, in particular methyl groups.

Examples of isocyanate-reactive compounds (B3b) comprising just one isocyanate-reactive hydroxyl group are in particular aliphatic, cycloaliphatic, araliphatic or aromatic monohydroxy carboxylic acids and monohydroxy sulfonic acids.

The polyurethane-based additives (B3) are prepared by reaction of the compounds (B3a) and (B3b) in a molar ratio of (B3a) to (B3b) which is generally in the range from 2:1 to 1:1 and preferably in the range from 1.2:1 to 1:1.2.

It is possible in this connection, as well as the aforementioned isocyanate-reactive compounds (B3b), to add further compounds having isocyanate-reactive groups, for example dithiols, thio alcohols, such as thioethanol, amino alcohols, such as ethanolamine and N-methylethanolamine, or diamines, such as ethylenediamine, to thereby prepare polyurethanes which, as well as the urethane groups, additionally bear isocyanurate groups, allophanate groups, urea groups, biuret groups, uretdione groups or carbodiimide groups. Further examples of such isocyanate-reactive compounds are aliphatic, cycloaliphatic, araliphatic or aromatic carboxylic acids and sulfonic acids which bear at least two primary and/or secondary amino groups.

It will be appreciated that it is also possible to add corresponding compounds having just one isocyanate-reactive group, examples being monoalcohols, primary and secondary monoamines, monoamino carboxylic acid and sulfonic acids and mercaptans. Customary use levels range up to 10 mol %, based on (B3a).

Preferably, some or all of the carboxyl groups of the reaction products (B3) are in salt form in order their solubility in water may be ensured. Useful salts include for example alkali metal salts, such as sodium and potassium salts, and ammonium salts.

Typically, the additives (B3) have average molecular weights M_{w} in the range from 500 to 250 000.

Specific surface-active properties can be achieved for the additives (B3) via the ratio of polar to apolar groups.

Such anionic surface-active additives (B3) are known and commercially available, for example under the name of Borchi® GEN SN95 (Borchers).

Water-soluble anionic surface-active additives based on acidic phosphoric, phosphonic, sulfuric and/or sulfonic esters of polyethers (B4) are based in particular on the reaction products of the above-recited polyethers (B1) with phosphoric acid, phosphorus pentoxide and phosphonic acid or sulfuric acid and sulfonic acid. The reaction converts the polyethers into the corresponding phosphoric mono- and diesters and phosphonic esters or sulfuric monoesters and sulfonic esters. These acidic esters are preferably present in the form of water-soluble salts, in particular as alkali metal salts, especially sodium salts, and ammonium salts, but they can also be used in the form of the free acids.

Preferred phosphates and phosphonates are derived in particular from alkoxylated, especially ethoxylated, fatty and oxo process alcohols, alkylphenols, fatty amines, fatty acids and resin acids, preferred sulfates and sulfonates are based in particular on alkoxylated, especially ethoxylated, fatty alcohols, alkylphenols and amines including polyfunctional amines, such as hexamethylenediamine.

Such anionic surface-active additives are known and commercially available, for example under the names of Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia) and Lutensit® (BASF).

Useful anionic surface-active additives based on polycondensation products of aromatic sulfonic acids and formaldehyde (B5) include in particular naphthalenesulfonic acid-formaldehyde condensates which are likewise preferably used in salt form, in particular as sodium salt.

The polycondensation products (B5) typically have average molecular weights M_{w} in the range from 4000 to 15 000.

Such anionic surface-active additives are likewise known and available, for example under the name of Tamol® (BASF).

The make-up of the pigment preparations to be used according to the present invention is a matter of discretionary choice. When a pigment preparation is to have a particularly high pigment content in the range from 70% to 90% by weight, it will be advantageous to use the additives (B1) to (B4) or their mixtures as component (B). Pigment preparations which are particularly quick and easy to redisperse on contact with water are obtainable for example by using 50% to 70% by weight of additive (B), in particular of additive (B5), and a correspondingly lower pigment fraction.

The pigment preparations to be used according to the present invention are obtainable when the pigment, which has preferably already been finished, i.e., converted into the desired particle shape and size, is initially subjected to a deagglomeration by wet comminution, for example wet grinding in a stirred ball mill, in the presence of some or preferably all of additive (B) and then to a drying operation, for example spray granulation, fluidized bed drying, spray drying, drying in a paddle dryer or evaporation and subsequent comminution.

The pigment preparations to be used according to present invention are very useful for coloring the cellulose particles used in cellulose polymer compounds or composites. The particles in question may consist of any naturally occurring cellulose variety and may be finely to coarsely divided. Preferred examples of these materials are wood shavings, wood fibers and wood dust.

The cellulose particles can be colored at various production stages. The chopping chips serving as starting material can be colored, but the cellulose particles can also be colored after their fabrication preferably in the moist state.

This will now be more particularly described by way of example with reference to wood fibers. As well as coloration of the chopping chips serving as a starting material, during which small amounts of water are added if they are not sufficiently moist, it is similarly possible for the moist wood fibers obtained after comminution by cooking and grinding to be contacted with the pigment preparations. The pigment preparations may here be applied to the wood fiber together with further auxiliaries for compound or composite production if desired.

The colored particles of cellulose, as usual for the manufacture of cellulose polymer compounds or composites, can then be mixed with the matrix polymer and jointly extruded.

When the polymer matrix is to be colored as well, this is simple to accomplish by incorporation of further pigment preparation of the invention or commonly known polymeric concentrates of pigment known as masterbatches in the extrusion operation.

1-8. (canceled)

9: A method of coloring cellulose polymer compounds or composites comprising the step of applying solid pigment preparations comprising, as essential constituents,
(A) 30% to 90% by weight of at least one pigment
and
(B) 10% to 70% by weight of at least one water-soluble surface-active additive

10: The method according to claim 9 wherein component (B) comprises at least one water-soluble surface-active additive from the group of nonionic additives based on polyethers (B1), anionic additives based on polymers of ethylenically unsaturated carboxylic acids (B2), anionic additives based on polyurethanes (B3), anionic additives based on acidic phosphoric, phosphonic, sulfuric and/or sulfonic esters of polyethers (B4) and the anionic additives based on polycondensation products of aromatic sulfonic acids and formaldehyde (B5).

11: A process for producing colored cellulose polymer compounds or composites, which comprises utilizing cellulose particles colored with pigment preparations according to claim 9.

12: The process according to claim 11 wherein the cellulose particles utilized are selected from the group comprising colored wood shavings, wood fibers, wood dusts and mixtures thereof.

13: The process according to claim 11 wherein the wood-chopping chips serving as starting material to produce the wood shavings, wood fibers and wood dusts are contacted with the pigment preparations.

14: The process according to claim 11 wherein the wood-chopping chips serving as starting material to produce the wood shavings, wood fibers and wood dusts are contacted with the pigment preparations and small amounts of water.

15: The process according to claim 13 wherein the moist wood fibers obtained by cooking and grinding are contacted with the pigment preparations.

16: The process according to claim 13 wherein the moist wood fibers obtained by cooking and grinding together with further auxiliaries for composite or compound production, are contacted with the pigment preparations.

17: The process according to claim 14 wherein the moist wood fibers obtained by cooking and grinding are contacted with the pigment preparations.

18: The process according to claim 14 wherein the moist wood fibers obtained by cooking and grinding together with further auxiliaries for composite or compound production, are contacted with the pigment preparations

19: The process according to claim 11 wherein the polymer matrix is additionally colored.

20: Cellulose polymer composites or compounds colored with pigment preparations according to claim 9.

21: Cellulose polymer composites or compounds colored with pigment preparations according to claim 10.
